(19) United States
(12) Patent Application Publication
(10) Pub. No.: US 2025/0131403 A1
(43) Pub. Date: Apr. 24, 2025

(54) INFORMATION PROCESSING SYSTEM AND INFORMATION PROCESSING METHOD

(71) Applicant: Toshiba Tec Kabushiki Kaisha, Tokyo (JP)

(72) Inventors: Yoichiro YAMADA, Numazu Shizuoka (JP); Satoshi TAKEI, Sakai Osaka (JP); Ryuta FUJII, Kashiwa Chiba (JP); Katsuhiko KAMASAKI, Osaka Osaka (JP); Taishi SANO, Yokohama Kanagawa (JP); Yukio NAGARA, Suginami Tokyo (JP)

(21) Appl. No.: 18/896,395

(22) Filed: Sep. 25, 2024

(30) Foreign Application Priority Data
Oct. 20, 2023 (JP) 2023-180798

(51) Int. Cl. G06Q 20/20; G06Q 20/38; G06Q 30/0207

(52) U.S. Cl. CPC G06Q 20/209; G06Q 20/387; G06Q 20/389; G06Q 30/0207

(57) ABSTRACT

According to one embodiment, an information processing system for handling accumulation of sales transaction data from multiple stores or the like includes a first communication processing unit to acquire transaction data related to sales transactions in a plurality of data formats, a first data processing unit to store, in a storage unit, the transaction data in a predetermined format, a second data processing unit to generate sales analysis information based on pieces of the transaction data in the predetermined format stored in the storage unit, and a second communication processing unit to output the sales analysis information generated by the second data processing unit.

### CROSS-REFERENCE TO RELATED APPLICATION

This application is based upon and claims the benefit of priority from Japanese Patent Application No. 2023-180798, filed Oct. 20, 2023, the entire contents of which are incorporated herein by reference.

### FIELD

Embodiments described herein relate to an information processing system, and an information processing method.

### BACKGROUND

Transaction data for customers at a retail store is used to analyze a transaction status such as store sales or customer purchase trends. The retail store may provide data to different data service operators (vendors) who provides a data analysis solution.

However, generally, a retail store needs to provide data for each data service operator in a format specific to the data service operator. For example, data required by the data service operator may be different for each data service operator. Similarly, an encryption tool for transmitting data to the data service operator may be different for each data service operator. The retail store may remove member ID data from transaction data to be shared or encrypt the transaction data using the encryption tool for each vendor (data service operator). Furthermore, the retailer may need to transmit aggregated transaction data to a data service operator or the transaction data may be transmitted as it is (without aggregation) to the data service operator. The retailer may also have to take various measures for each data service operator such a preprocessing of the data or the like. In this way, when a data cooperation destination differs for each solution (vendor), data cooperation work will have to occur for each of the of solutions. Therefore, the workload for the retail store is large.

The format in which the transaction data is generated depends on the particular software executed by a point of sales (POS) device. With emergence of various settlement methods, the location in which settlement information is stored as a record in the format of the transaction data may differ depending on the settlement method. The format of the transaction data can be an original or unique specification of each store or equipment vendor, and the location in which the member ID is stored in the transaction data may thus differ depending on the transaction data format. Depending on how each store handles cash vouchers, local gift certificates, coupons, and the like, the format of the transaction data may also differ. In this way, when the formats of the transaction data are different, work for unifying the transaction data formats also occurs.

As described above, distribution of the transaction data across multiple platforms requires a lot of work.

### BRIEF DESCRIPTION OF THE DRAWINGS

FIG. 1 is a block diagram schematically showing a configuration example of a server according to an embodiment.

FIG. 2 is a diagram showing an example of a data structure of second POS data.

FIG. 3 is a flowchart showing an example of collection processing of second POS data.

FIG. 4 is a flowchart showing another example of collection processing.

FIG. 5 is a flowchart showing an example of output processing of display information.

FIG. 6 is a flowchart showing another example of the output processing.

FIG. 7 is a flowchart showing an example of setting of an extraction condition.

FIG. 8 is a flowchart showing an example of setting of use authority.

FIG. 9 is a diagram showing an example of a screen image for inputting an extraction condition.

FIG. 10 depicts a chart related to display of aggregated sales data.

FIG. 11 is a diagram showing an example of a screen image for inputting an extraction condition.

FIG. 12 is a diagram showing an example of a screen image for inputting use authority for another vendor.

### DETAILED DESCRIPTION

In general, according to one embodiment, a devices, systems, and methods for supporting accumulation and distribution of transaction data is provided.

According to an embodiment, an information processing system includes a first communication processing unit configured to acquire transaction data related to sales transactions in a plurality of data formats, a first data processing unit configured to store, in a storage unit, the transaction data in a predetermined format, a second data processing unit configured to generate sales analysis information based on pieces of the transaction data in the predetermined format stored in the storage unit, and a second communication processing unit configured to output the sales analysis information generated by the second data processing unit.

### Embodiments

Hereinafter, certain example embodiments will be described with reference to the drawings. In the drawings, the depicted dimensions, scale, relative sizing and the like of each aspect may vary for those of an implemented embodiment. The aspects may be omitted from the drawings for the sake of simplified description of relevant aspects.

### Configuration Example

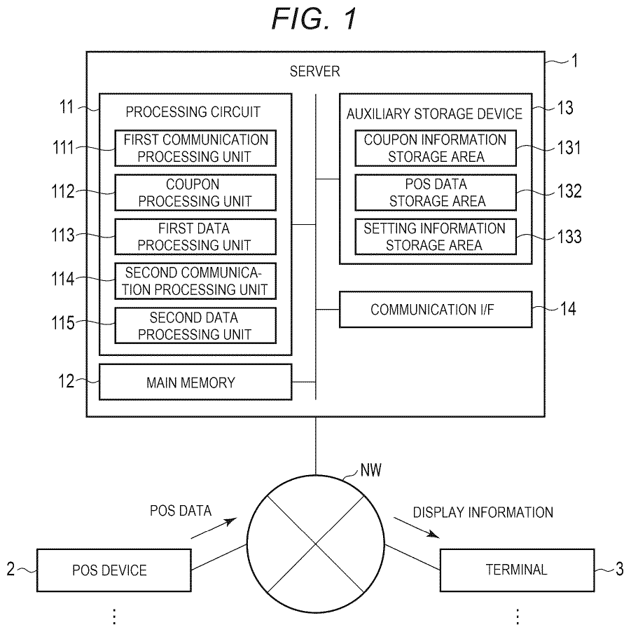

FIG. 1 is a block diagram schematically showing a configuration example of a server 1 for a multiuser sales data analysis system.

The server 1 is a device that supports distribution of point of sales (POS) data to multiple users or the like. For example, the server 1 provides a cloud service related to data distribution.

In this context, “POS data” is transaction data collected from a POS device 2. The transaction data is data related to a transaction commodity (a commodity involved in a sales transaction). The POS data can be data for an individual transaction commodity or several. The POS data is generated by the POS device 2 during sales transaction processing performed by the POS device 2. The POS data can be initially stored in the POS device 2. The format of the POS data depends on the particular software executed by the POS device 2. Therefore, the format of the POS data may be different for each type of POS device 2, particularly for different vendors (manufacturers) of POS devices. That is, format of the POS data may be vendor-specific or the like. When formatting is different, the storage location for particular information in the POS data may differ. For example, the location in which a member number (e.g., customer identifying information) is stored in the POS data may differ depending on the format of the POS data. Depending on how each sales vendor handles cash vouchers, regional gift certificates, coupons, and the like, the format of the POS data may also differ. In such cases, the indicators and positioning of data associated with usage of coupons, gift vouchers, or applied discounts may vary.

In the present context, a transaction commodity can be any commodity, item, product, merchandise, service, or the like sold at a store. In general, the transaction involves a customer picking up an item, registering the item in the transaction, then paying for the item at a POS device 2 or the like. The transaction is a purchase transaction from the viewpoint of a customer and sales transaction from the viewpoint of a store. A sales commodity is any commodity sold at a store. The commodity may be a physical commodity or an intangible commodity, such as a service or a ticket for a service or the like. The customer purchase may involve a customer in-person visit to a store or an online store (online purchase, web purchase, or the like). As such, the store in an embodiment may be a physical store or an electronic commerce (EC) store. The store may be operated by a retailer. The retailer is a vendor that operates the store. The retailer may be of any type. The retailer may operate a store that sells commodities of many types, such as a supermarket or a convenience store. The retailer may operate a store that sells commodities of a specific type. The retailer may operate multiple stores, a store chain, a multiple vendor market, or the like. A retailer group is a group that operates stores that are recognized as affiliated even if not all of the same individual brand or the like. For example, a retailer group operates stores under the same name and may include franchisees with which the retailer engages as a franchisor. The retailer is an example of an organization.

The POS data includes data of various types and details. For example, the POS data may include or not a member number, a store code, a terminal number, a transaction number, a transaction date, a transaction time point, a commodity code, a unit price, a quantity sold, and a transaction amount. The POS data may include other information beyond or different from these items.

In this context, a member number is a code capable of uniquely identifying a customer as a member of a retail business program (e.g., a customer loyalty program) operated by a retailer. The store code is a code capable of uniquely identifying a store. The terminal number is a code capable of uniquely identifying the POS device 2 at which a transaction was performed. The transaction number is a code capable of uniquely identifying a particular transaction. The transaction date is the calendar date when a transaction occurred. The transaction time point is the time (e.g., hh:mm:ss) when the transaction occurred. The commodity code is a code capable of uniquely identifying a commodity. The unit price is a price paid per transacted commodity. Hereinafter, information regarding a unit price included in the POS data is also referred to as a transaction price. In this context, the “quantity” item in the transaction data refers to the number of transacted commodities of the same type in a transaction, this is also referred to as a transacted quantity. The “amount” item in the transaction data is the amount (money) due for all the commodities in a transaction and may be referred to as a transaction total or transaction total amount. The transaction amount may generally be obtained by multiplying the unit price and the transacted quantity for each of the different commodities in the transaction and summing the values for every commodity in the transaction.

The server 1 provides content and display information to a terminal 3.

The display information can be displayed on the terminal 3. For example, the display information is image information for displaying content on the terminal 3. The display information may be information for displaying content in a table format or in a graph format. The display format for the content is not limited thereto. The content may be displayed in one display area or distributed among a plurality of display areas. The display area is any screen area or the like for displaying content. The display area may be for a graph or a table or may be a browser window or the like. The possible display areas are not limited thereto.

The content is generated by the server 1 based on a plurality of pieces of POS data. The content may be related to transaction performance. The transaction performance is a value representing performance of a transaction obtained based on aggregation of the plurality of pieces of POS data. For example, the transaction performance can be a specific retailer. The specific retailer may be one store or may be multiple stores, such as a chain of stores. The aggregation of the plurality of pieces of POS data is a process of collecting the plurality of pieces of POS data.

In one example, a value obtained based on the aggregation of the plurality of pieces of POS data is an aggregation value of any item included in the plurality of pieces of POS data. The aggregation value may be a value obtained by summing up values included in the plurality of pieces of POS data. For example, the aggregation value may be obtained by summing up the transaction amount, the transaction prices, or the transacted quantity, but is not limited thereto. The aggregation value may be obtained by uniquely counting any item included in the plurality of pieces of POS data. For example, an aggregation value can be the number of unique customers (obtained by uniquely counting the member numbers), but is not limited thereto. The aggregation value may be a corrected value. For example, a correction is rounding, but is not limited thereto. The correction may be any calculation changing the underlying value. Rounding is calculation processing for changing the value according to set rules. The rounding is processing such as rounding up, rounding down, and rounding off, but is not limited thereto.

In another example, a value obtained based on the aggregation of the plurality of pieces of POS data is a statistical value based on the aggregation value of one or more items. The statistical value is obtained by calculation using the aggregation value of one or more items. For example, a statistical value can be an average value, a difference between values, a ratio of values, or the like, but is not limited thereto. The statistical value may also be a corrected value. For example, a statistical value may be subjected to a correction such as rounding, but is not limited thereto.

For example, the display information is generated based on processing of data. The data generated by the processing of data can be data generated based on the aggregation of the plurality of pieces of POS data. The processing of data can include a transaction performance.

The server 1 is communicably connected to the POS device 2 via a network NW. The network NW includes one or more networks such as the Internet, a mobile communication network, and a local area network (LAN). The LAN may be a wireless LAN or a wired LAN. Although FIG. 1 shows one POS device 2, the server 1 communicates with a plurality of POS devices 2.

The server 1 is communicably connected to the terminal 3 via the network NW. Although FIG. 1 shows one terminal 3, the server 1 communicates with a plurality of terminals 3.

The server 1 may be implemented as one device or may be implemented as a plurality of devices in which functions are distributed. The server 1 is an example of an information processing system implemented by one device or a plurality of devices. The information processing system implemented by one device is also referred to as an information processing device.

The POS device 2 processes a sales transaction and generates transaction data. For example, the POS device 2 has a settlement function for processing payments for settling a transaction. In some examples, POS device 2 may additionally or instead have a commodity registration. The POS device 2 may be a device installed in a store or may be a device that provides a cloud-based service without necessarily being in the store.

The terminal 3 can be any terminal-type device capable of displaying information. The terminal 3 may be a tablet terminal, a smartphone, a personal computer (PC), or the like, but is not limited thereto.

A configuration example of the server 1 will be described.

The server 1 includes a processing circuit 11, a main memory 12, an auxiliary storage device 13, and a communication interface 14. In FIG. 1, the interface is described as “I/F”.

The processing circuit 11 corresponds to a central part of the server 1. The processing circuit 11 includes one or more circuits that execute a plurality of processing using a plurality of functions. For example, the circuit is a processor, an application specific integrated circuit (ASIC), or a field-programmable gate array (FPGA), but is not limited thereto. For example, the processor is a central processing unit (CPU) or a graphics processing unit (GPU), but is not limited thereto. The processing circuit 11 loads a program stored in advance in the main memory 12 or the auxiliary storage device 13 into the main memory 12. The program is a program capable of causing the processing circuit 11 to execute processing to be described later. The processing circuit 11 executes a program loaded in the main memory 12 to enable execution of various types of processing.

The main memory 12 can comprise a nonvolatile memory area and a volatile memory area. The main memory 12 stores an operating system or a program in the nonvolatile memory area. The main memory 12 uses the volatile memory area as a work area in which data is appropriately rewritten by the processing circuit 11. For example, the main memory 12 includes a read only memory (ROM) as the nonvolatile memory area. For example, the main memory 12 includes a random access memory (RAM) as the volatile memory area.

The auxiliary storage device 13 can be one or more storage devices. Examples of a storage device include an electric erasable programmable read-only memory (EEPROM), a hard disc drive (HDD), a solid-state drive (SSD), and a flash memory, but are not limited thereto. The auxiliary storage device 13 stores the program, data used by the processing circuit 11 to perform various types of processing, and data generated by the processing in the processing circuit 11. Each storage area of the auxiliary storage device 13 may be in one device or may be distributed among a plurality of devices. Each storage area is an example of a storage unit of the server 1.

The auxiliary storage device 13 includes a coupon information storage area 131. The coupon information storage area 131 stores coupon information about coupons that might be or have been used in a transaction. The coupon provides a benefit useful for a customer. Examples of the coupon include free exchange of commodities, discount, and reward point granting, but are not limited thereto. The coupon information is information indicating such things as a value, a use eligibility condition, valid dates, and the like of a coupon. The coupon information may be correlated to a coupon dispensing condition. The coupon dispensing condition is a condition set for the dispensing of a coupon to a customer or the like. For example, the coupon dispensing condition relates s to purchase of a particular transaction commodity or the transaction amount threshold, but is not limited thereto. Data in the coupon information storage area 131 can be changed by addition, updates, or deletion of the coupon information and/or dispensing conditions.

The auxiliary storage device 13 includes a POS data storage area 132. The POS data storage area 132 stores the POS data (sales transaction data) in a predetermined format. The POS data stored in POS data storage area 132 is generally the POS data acquired by the server 1 from the POS devices 2. The various POS devices 2 may generate or transmit POS data (sales transaction data) in a format different than the predetermined format. The POS data may be supplied from the POS devices 2 on a per transaction basis. The predetermined format is a predetermined data format. The predetermined format does not depend on the software executed by the particular POS device 2 that originally generated the POS data. The predetermined format can be appropriately set by an operator or administrator of the server 1. Hereinafter, the POS data in the format acquired by the server 1 from a POS device 2 is also referred to as first POS data (or first-type POS data). The POS data in the predetermined format is referred to as second POS data (or second-type POS data). The first POS data and the second POS data are examples of transaction data. Data in the POS data storage area 132 can be updated by adding or deleting the second POS data.

A coupon may be dispensed in a paper form or distributed as electronic data to an e-mail or an application installed in a smartphone.

The auxiliary storage device 13 includes a setting information storage area 133. The setting information storage area 133 stores setting information. The setting information concerns setting related to the second POS data stored in the POS data storage area 132.

In one example, the setting information storage area 133 stores setting information related to an extraction condition that has been previously set by a retailer or the like. The setting information related to the extraction condition reflects the extraction conditions set for filtering particular second POS data stored in the POS data storage area 132 for purposes of analysis, reporting or the like. The extraction condition is a condition for extracting the second POS data which is then used for generating content display information. The extraction condition can be set for each type of the display information.

The extraction condition may relate to extracting transaction data of a store owned by a specific retailer or group of stores owned or operated by a specific retailer. For example, the extraction condition may relate to extracting transaction of data of stores in a business category or classification such as a supermarket, a home center, a convenience store, or a pharmacy. The transaction data may be extracted for stores in specific area, geographic region, or the like from among all stores owned by a specific retailer. The specific area of concern may be a region or an area such as the Kanto region or the Kansai region, a prefecture, or a city, a ward, a town, or a village. Transaction data for a single store from among all stores owned by a specific retailer may be extracted. The processing circuit 11 can extract, based on store code data included in the second POS data, the data satisfying the conditions related to a store owned by a specific retailer.

The extraction conditions may be related to the item involved in the sales transaction. The extraction condition may be related to a single, specific commodity (e.g., same commodity code), a grouping of commodities, a specific type or class of commodity, commodity price, or the like. The commodity can be a physical commodity such as food or clothing or a service, a ticket, or the like. The target range of the commodity may be a commodity of a specific commodity type. For example, a commodity type can be any classification or grouping such as clothing and food. The processing circuit 11 can extract information related to specific commodities based on commodity code data included in the second POS data.

The extraction condition may include a condition related to a transaction time, a transaction date, a time period, or the like. Such a time period may be referred to as an evaluation period, analysis period, or the like. Extraction conditions related to times, dates, and periods may be set arbitrarily. The processing circuit 11 can extract such information based on transaction time data and/or transaction date data included in the second POS data.

The extraction condition may be related to a customer attribute. Such attributes may include gender or any customer demographic data. The processing circuit 11 can extract such information based on customer attribute data associated with a member number data included in the second POS data.

Once the extraction conditions are set, the processing circuit 11, at a predetermined timing, generates the display information based on a plurality of pieces of second POS data satisfying the extraction conditions. The predetermined timing may be set by the server 1 or may be set by a user. The predetermined timing may be different or may be the same regardless of the selected content for display.

The setting information storage area 133 may store the setting information on the extraction condition for each of other vendors to be described later.

Data in the setting information storage area 133 is updated by setting or deleting an extraction condition. The setting of an extraction condition includes not only making a new setting but also a making a change to existing settings.

In another example, the setting information storage stores use authority setting information. The use area 133 authority setting information is information indicating the use authority that may permit another vendor/retailer to access or generate content based on the second POS data generated according to sales by another vendor/retailer and stored in the POS data storage area 132. In this context, a vendor different from the retailer who provided the second POS data may be given permission to view, use, access, or analyze the retailer's stored second POS data. For example, the other vendor can be a product manufacturer or a wholesaler, but is not limited thereto. The other vendor can be any other organization. The use authority is permission to use the second POS data. The use authority may cover multiple stores owned by the retailer. The range of the stores may include an individual store, a business category of the store, or an area of the store. For example, the retailer may provide use authority to another vendor as part of a selling of data to the other vendor.

Data in the setting information storage area 133 can be updated by setting or deleting the use authority.

The communication interface 14 communicably connects the server 1 to another device. The communication interface 14 is an example of a communication unit of the server 1.

The hardware configuration of the server 1 is not limited to the above-described configuration. In the server 1, the above-described constituent elements may be appropriately omitted and changed, and other constituent elements may be added thereto.

Functions implemented by the processing circuit 11 will be described.

The processing circuit 11 implements a first communication processing unit 111, a coupon processing unit 112, a first data processing unit 113, a second communication processing unit 114, and a second data processing unit 115. Each unit implemented by the processing circuit 11 can also be referred to as a function. Each unit implemented by the processing circuit 11 can also be considered to be implemented by a control unit, controller, or the like including the processing circuit 11 and the main memory 12.

The first communication processing unit 111 handles communication between the server 1 and the POS device 2 via the communication interface 14. For example, the first communication processing unit 111 acquires the first POS data from the POS device 2 via the communication interface 14. A format of the first POS data generally depends on the POS device 2 that sends the first POS data. In some instances, a POS device 2 may send first POS data already in a predetermined format. For example, the first communication processing unit 111 also outputs coupon information to the POS device 2 via the communication interface 14.

The coupon processing unit 112 can extract coupon information from the coupon information storage area 131 based on the first POS data.

The first data processing unit 113 stores the second POS data in the POS data storage area 132 by converting as necessary or the like the first POS data into the predetermined format of the second POS data.

The second communication processing unit 114 handles communication between the server 1 and the terminal 3 via the communication interface 14. For example, the second communication processing unit 114 acquires, from the terminal 3, a request input by a user at terminal 3. For example, the second communication processing unit 114 outputs display information to the terminal 3 via the communication interface 14.

The second data processing unit 115 generates the display information based on second POS data stored in the POS data storage area 132. The second data processing unit 115 sets the extraction condition(s) based on the operations performed by a user at the terminal 3. The second data processing unit 115 sets a use authority based on the operations performed by the user at the terminal 3.

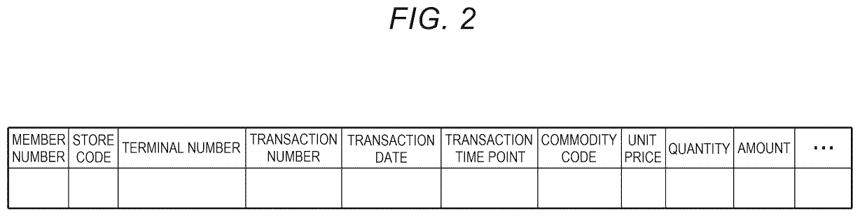

FIG. 2 is a diagram showing an example of a data structure of the second POS data.

In the example, the second POS data includes data for a member number, a store code, a terminal number, a transaction number, a transaction date, a transaction time point, a commodity code, a unit price, a quantity, and an amount.

### Operation Example

Next, processing in the server 1 will be described.

The processing procedure described below is merely an example, and processing may be changed or varied. Additionally, certain acts, steps, or the like in the processing procedure described below can be omitted, replaced, or substituted. Furthermore, acts, steps, or the like can be added thereto as appropriate according to an embodiment.

In the following description, functions implemented by certain “units” provided the processing circuit 11 will be mainly described, and the description will refer to these units, but the description can be considered as indicating that any function of a unit can be implemented by the processing circuit 11 itself.

Two examples of collection processing of the second POS data performed by the processing circuit 11 of the server 1 will be described.

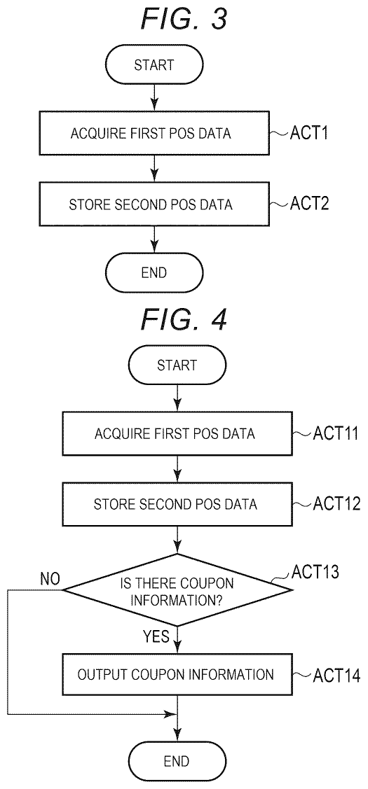

FIG. 3 is a flowchart showing an example of the collection processing of the second POS data performed by the processing circuit 11 of the server 1.

The processing circuit 11 of the server 1 executes the processing shown in FIG. 3 on a per transaction basis. Each piece of second POS data may be considered associated with a transaction commodity (e.g., a commodity code of an item sold in the underlying transaction).

The first communication processing unit 111 acquires the first POS data (ACT 1). In ACT 1, the first communication processing unit 111 acquires the first POS data from the POS device 2 via the communication interface 14.

The first data processing unit 113 stores the second POS data in the POS data storage area 132 based on the acquired first POS data (ACT 2).

A case in which the format of the first POS data is already the predetermined format will be described. In such an example, the second POS data is exactly the same as the first POS data. Thus, the first data processing unit 113 may store the acquired first POS data already in the predetermined format in the POS data storage area 132 as second POS data without reformatting or conversion processing.

A case in which the format of the first POS data is a format other than the predetermined format will be described. In such an example, the second POS data is data obtained by converting the format of the first POS data. The first data processing unit 113 converts the first POS data into the predetermined format as necessary. The first data processing unit 113 generates the second POS data by conversion processing. The first data processing unit 113 stores the generated second POS data in the POS data storage area 132.

As described above, the server 1 can generate the second POS data by converting the format of the first POS data into the predetermined format.

Accordingly, the server 1 can manage POS data from a plurality of different POS devices 2 in a unified format.

FIG. 4 is a flowchart showing another example of the collection processing of the second POS data performed by the processing circuit 11 of the server 1.

The example shown in FIG. 4 is different from the example shown in FIG. 3 in that the server 1 acquires the first POS data from the POS device 2 as part of an inquiry for the coupon information.

The processing circuit 11 of the server 1 executes the processing shown in FIG. 3 on a per transaction basis.

The first communication processing unit 111 acquires the first POS data (ACT 11). In ACT 11, the first communication processing unit 111 acquires the first POS data from the POS device 2 as part of an inquiry for coupon information.

In this example, the POS device 2 that performs the inquiry for the coupon information has a different POS data format from the predetermined format, however, the application software used for inquiring about coupon information from the server 1 is common application software installed in each POS device 2, and therefore the format of the first POS data supplied for inquiring about the coupon information is a common format. The POS device 2 coupon inquiry software thus converts the POS data generated by the POS device 2 to a common first POS data format and stores the data. The POS device 2 then transmits the first POS data (coupon inquiry format) to the server 1.

The first data processing unit 113 stores the second POS data in the POS data storage area 132 based on the first POS data as acquired by the first communication processing unit 111 (ACT 12). The processing in ACT 12 is the same as the processing in ACT 2.

The coupon processing unit 112 extracts the coupon information from the coupon information storage area 131 using the first POS data (ACT 13). In ACT 13, for example, the coupon processing unit 112 compares the transaction commodities or the overall transaction information represented in the first POS data to the coupon dispensing conditions stored in the coupon information storage area 131. If a transaction commodity or the transaction represented by the first POS data satisfies the coupon dispensing condition, the coupon processing unit 112 extracts the coupon information meeting the coupon dispensing condition(s) from the coupon information storage area 131.

If the coupon processing unit 112 extracts coupon information from the coupon information storage area 131 (ACT 13, YES), the processing transitions from ACT 13 to ACT 14. If the coupon processing unit 112 does not extract coupon information from the coupon information storage area 131 (ACT 13, NO), the processing ends.

The first communication processing unit 111 then outputs the coupon information extracted by the coupon processing unit 112 (ACT 14). In ACT 14, the first communication processing unit 111 outputs the coupon information to the POS device 2 via the communication interface 14. When the coupon information is acquired from the server 1, the POS device 2 provides a corresponding coupon to the customer. The POS device 2 may provide the coupon to the customer by dispensing a piece of paper (printed coupon) or provide the coupon electronically (electronic coupon).

As described above, the server 1 acquires the first POS data output from the POS device 2 as part of the inquiry for the coupon information.

In such a case, the server 1 can collect the first POS data without requiring the retailer to separately upload the first POS data to the server 1. Therefore, the retailer can avoid the work of uploading the first POS data.

Two examples of output processing of the display information performed by the processing circuit 11 of the server 1 will be described.

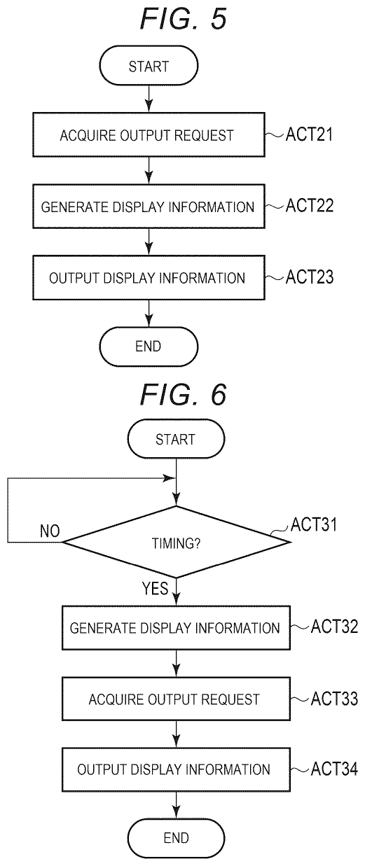

FIG. 5 is a flowchart showing an example of the output processing of the display information performed by the processing circuit 11 of the server 1.

Here, a user of the retailer accesses the server 1 using the terminal 3 in order to display content on the terminal 3 (e.g., an image). The user uses the terminal 3 to select particular content from available content and input the extraction condition for extracting the second POS data used to generate the display information. The input extraction condition may be information indicating particular content. After inputting the extraction condition, the user inputs an output instruction using the terminal 3. The output instruction is an instruction for causing the server 1 to output content display information to the terminal 3. The output instruction is also an instruction to display an image on the terminal 3. The terminal 3 then outputs an output request and the extraction condition to the server 1. The output request is a request for causing the server 1 to output the content display information to the terminal 3.

The second communication processing unit 114 acquires the output request and the extraction condition (ACT 21). In ACT 21, the second communication processing unit 114 acquires the output request and the extraction condition from the terminal 3 via the communication interface 14.

The second data processing unit 115 generates the display information based on the plurality of pieces of second POS data (ACT 22). The second data processing unit 115 generates the display information for particular content selected by the user. In ACT 22, the second data processing unit 115 searches from the POS data storage area 132 for second POS data satisfying the extraction condition indicated by the input information. The second POS data is stored in the POS data storage area 132. The second POS data is data collected from one or more POS devices 2. The second POS data is data related to a plurality of transaction commodities. The second POS data includes data for a specific retailer. If the specific retailer is just one retailer, the second POS data is from the same retailer. The plurality of transaction commodities are sales commodities for the same retailer.

The second data processing unit 115 generates the display information based on the second POS data satisfying the extraction condition. For example, the second data processing unit 115 generates the processed data based on the aggregation of the different second POS data satisfying the extraction condition. The processed data can be the transaction performance data. The second data processing unit 115 can obtain the transaction performance data based on the aggregation of second POS data. The second data processing unit 115 generates the content display information based on the processed data.

Here, the transaction performance data included in the processed data can differ according to the selected content. The processed data can include the transaction performance data on a per processing unit (group) basis. In this context, a processing unit is a collection or grouping for obtaining the transaction performance data. The processing unit may be defined based one item or two or more different items. Hereinafter, several examples of the processing unit will be described, but are not limited thereto.

The processed data can include the transaction performance data for at least one processing unit defined in the target range of the set extraction conditions. The processing unit (grouping) can be based on store ownership, business category, geographic or political regions, or the like. A processing unit may be based on multiple dimensions, such as a particular business category within a particular geographic region or the processing unit may be set as two or more different business categories, or the like. The processing unit may be defined by the retailer, the user, or determined according to the intended type of output content.

The processed data can include the transaction performance data for at least one processing unit defined by commodity, commodity type, commodity category, commodity classification, commodity characteristics or set by the retailer, the user, or according to the intended type of content to be output.

The processed data can include the transaction performance data for at least one processing unit defined according to time period or the like.

The processed data can include the transaction performance data for a processing unit defined by deciles. In this context, a decile is a group of customers divided into 10 equal sub-groups in descending order of a purchase amount.

The second data processing unit 115 searches for, on a per processing unit basis, one or more pieces of second POS data included in the processing unit from among the plurality of pieces of second POS data satisfying the extraction condition. For example, the second data processing unit 115 can search for, based on various types of data such as the transaction date, the transaction time point, the store code, and the commodity code included in the second POS data, one or more pieces of second POS data included in the processing unit. The second data processing unit 115 can obtain, on a per processing unit basis, the transaction performance based on one or more pieces of second POS data included in the processing unit.

Accordingly, the server 1 can generate the processing data for each content type based on the aggregation required for each content type. Therefore, the server 1 can provide a platform that enables outputting of information corresponding to various content types.

The content display information is information generated based on the processing data. The content display information is information for displaying on the terminal 3. The display of content or information includes a display based on the transaction performance data in the content.

The display of transaction performance data can be a display indicating transaction performance according to a content display format. The display indicating the transaction performance can be a display indicating a value of the transaction performance. The display indicating the transaction performance can be not only a display indicating the value of the transaction performance on a single transaction basis, but also may be a display indicating a value of the transaction performance on a customer basis or a store basis. For example, if the transaction performance includes the transaction price, a display indicating the transaction price can be a display indicating a value of the transaction price as a purchase price or a sales price.

The display based on the transaction performance can be a display indicating a value obtained by correcting or adjusting the transaction performance. For example, correction may be rounding, but is not limited thereto. The correction may be calculation for changing the value of the transaction performance. The display based on the transaction performance can be a display indicating a value obtained by correcting the transaction performance according to the content display format. The display indicating the value obtained by correcting the transaction performance can be not only a display indicating the value obtained by correcting the transaction performance on a single transaction basis, but also a display indicating a value obtained by correcting the transaction performance on a per purchase basis or total sales basis.

The display of content (content display) can be a display based on the transaction performance for at least one processing unit within the target range of a retailer. The display of content can be a display based on the transaction performance for at least one processing unit within the target range of a commodity. The display of content can include a display based on the transaction performance for at be one processing unit with the target range of a target period. The display of content can be a display based on the transaction performance for a processing unit defined as deciles.

The content display can include a display of information capable of identifying the processing unit. For example, if the processing unit is defined by each commodity included in a target range, the information for identifying the processing unit can be the name of the commodity or the like. The content display may include other kinds of information additionally or instead.

The second communication processing unit 114 outputs the display information generated by the second data processing unit 115 (ACT 23). In ACT 23, for example, the second communication processing unit 114 outputs the display information to the terminal 3 via the communication interface 14. The terminal 3 displays an image based on the display information.

As described above, the server 1 can output the display information to the terminal 3 of a user associated with a specific retailer or the like.

Accordingly, the server 1 can output, to the terminal 3 of a user at a specific retailer, the information corresponding to various content based on the plurality of pieces of second POS data from the specific retailer.

The retailer can then readily acquire information corresponding to various content by accessing the server 1, thereby improving convenience.

Here, the user who receives content related to or involving a specific retailer at a terminal 3 need not necessarily be associated with the specific retailer, but rather may be associated with another retailer, vendor, or the like. In this case, the second POS data used for generating the display information can be any pieces of data for which the use authority is set to permit access by the other retailer, vendor, user, or the like. Therefore, the second POS data can include data for from another retailer, vendor, store, or the like in addition to or instead of just data associated with the user's own retailer, vendor, store, or the like. The second POS data may be data for stores of the same retailer. The second POS data may be data from multiple retailers, depending on the use authority that has been set.

As described above, the server 1 can output, to the terminal 3 of a user, the content based on any second POS data for which the use authority has been set as usable by the user (or the user's associated retailer, vendor, etc.).

A vendor can acquire information corresponding to various content or solutions by accessing the server 1, thereby improving convenience.

An example of content will be described.

For example, content includes “sales” content, “customer analysis” content, and “recommendation” content. The “sales” content allows analysis of sales at a specific retailer. The sales content can include the total sales amount at the specific retailer in various sales transactions. The “customer analysis” content allows analysis of a customer purchase trend at a specific retailer. The “recommendation” content allows analysis of potential improvement points at a specific retailer. The “sales” content may include a “prompt sales report” and “sales aggregation” content. The “customer analysis” may include a “decile analysis”, a “ABCD analysis”, and “brand switch” analysis. The “recommendation” content may include “dynamic pricing” content and “commodity alignment” content, but is not limited thereto.

Example content of a “prompt sales report” will be described.

The “prompt sales report” is a content related to the sales at different time points for aggregation. For example, the aggregation may be performed for predetermined time ranges during a day of operation. In the following description, transaction performance data for various types will be delineated from each other using a designation corresponding to “transaction performance (X),” where X is any alphabetic letter.

In an example, the transaction performance can be transaction performance (A). The transaction performance (A) is an aggregation value over a plurality of time ranges during an operating day. The transaction performance (A) corresponds to the sales during the different time ranges at one store. The processing data includes the transaction performance (A) on a per processing unit basis. The second data processing unit 115 can obtain the transaction performance (A) based on the transaction amounts included in the second POS data.

For example, the processing data can include the transaction performance (A) for a group or collection of stores. The processing data can include the transaction performance (A) for different regions. The processing data may include the transaction performance (A) for different combinations of business category and region. The processing data can include the transaction performance (type A) for product sales or non-product sales. The processing data can include the transaction performance (A) for each commodity type or class.

A display of the content of “prompt sales report” can be a display based on the transaction performance (A) in relation to the sales at the different time points of the aggregation processing. The display of the content of “prompt sales report” is not limited to the above-described example.

The retailer can understand, using the content of “prompt sales report”, the sales at different time points for a collection of stores or a collection of commodities.

The “sales aggregation” content will be described.

Sales aggregation content includes an amount obtained by aggregating sales over two days or more.

In the example, the transaction performance can be transaction performance (B). The transaction performance (B) is an aggregation value obtained by summing up the transaction amounts over two days or more. The transaction performance (B) corresponds to the sales aggregation can be on per store basis or a per processing unit (group) basis. The second data processing unit 115 can obtain the transaction performance (B) based on the transaction amounts included in the second POS data.

The transaction performance can be transaction performance (C). The transaction performance (C) can be a statistical value obtained by dividing the transaction performance (B) from a certain year by the transaction performance (B) of another year. The statistical value can be a ratio of a current year value by the previous year value. The transaction performance (C) may be on per store basis or a per processing unit basis. The second data processing unit 115 can obtain the transaction performance (C) based on the transaction amounts included in the second POS data.

For example, the processing data can include all or a part of the transaction performance (B) and the transaction performance (C) for all stores collectively. The processing data can include all or a part of the transaction performance (B) and the transaction performance (C) for different regions. The processing data can include all or a part of the transaction performance (B) and the transaction performance (C) for each commodity type. The processing data can include all or a part of the transaction performance (B) and the transaction performance (C) in the entire target period. The processing data can include all or a part of the transaction performance (B) and the transaction performance (C) for different predetermined periods in the target period.

A display of “sales aggregation” content includes a display based on the transaction performance (B) in relation to the sales aggregation. The display of “sales aggregation” content includes a display based on the transaction performance (C) in relation to the previous year ratio of the sales aggregation. The display of “sales aggregation” content is not limited to the above-described examples.

The retailer can understand, using the “sales aggregation” content, changes in sales aggregation from the viewpoint of a collection of stores or a collection of commodities.

The “decile analysis” content will be described.

The “decile analysis” content is a content related to purchase performance for each decile. In this context, purchase performance can be a completion of purchase of commodities made by a customer. For example, the purchase performance information includes a total purchase amount, a purchase amount ratio, and/or a purchase amount per person, but is not limited thereto. The total purchase amount is an amount obtained by summing up the purchase amounts of customers. The purchase amount ratio is a ratio of the total purchase amounts of one decile to the total purchase amounts of all deciles. The purchase amount per person can be an average value of the purchase amounts of customers included in one decile.

In an example, the transaction performance can be transaction performance (D). The transaction performance (D) is an aggregation value obtained by summing up the transaction amounts for each decile. The transaction performance (D) corresponds to the total purchase amount per customer. The processing data includes the transaction performance (D) for each decile. The second data processing unit 115 can obtain the transaction performance (D) based on the transaction amounts included in the second POS data.

The transaction performance can be transaction performance (E). The transaction performance (E) can include a statistical value obtained by dividing a value obtained by summing up the transaction performance (D) of all the deciles by the transaction performance (D) of one decile. The statistical value is a ratio. The transaction performance (E) corresponds to the purchase amount ratio per customer. The processing data can be the transaction performance (E) on a per processing unit basis (group basis). The second data processing unit 115 can obtain the transaction performance (E) based on the transaction amounts included in the second POS data.

The transaction performance can be transaction performance (F). The transaction performance (F) is a statistical value obtained by dividing the transaction performance (D) by the number of customers included in one decile. The transaction performance (F) corresponds to the purchase amount per person from the viewpoint of purchase by the customer. The processing data can be the transaction performance (F) on a per processing unit (group) basis. The second data processing unit 115 can obtain the transaction performance (F) based on the transaction amounts included in the second POS data.

For example, the processing data can include all or a part of the transaction performance (D), the transaction performance (E), and the transaction performance (F) for each decile for all stores collectively. The processing data can include all or a part of the transaction performance (D), the transaction performance (E), and the transaction performance (F) for each decile for all commodities collectively. The processing data can include all or a part of the transaction performance (D), the transaction performance (E), and the transaction performance (F) for each decile in the entire target period.

A display of “decile analysis” content can be a display based on the transaction performance (D) in relation to the total purchase amount. The display of “decile analysis” content can be a display based on the transaction performance (E) in relation to the purchase amount ratio. The display of “decile analysis” content can be a display based on the transaction performance (F) in relation to the purchase amount per person. The display of “decile analysis” content is not limited to the above-described examples.

The retailer can understand the purchase trend for each decile using the “decile analysis” content.

The “ABCD analysis” content will be described.

The “ABCD analysis” content is a content related to sales performance of each individual commodity. The sales performance can concern performance of sales of commodities by a store. For example, the sales performance can be all or a part of store sales, a sales quantity, and a sales amount ratio for each decile, but is not limited thereto. The sales quantity is the number of commodities sold by the store. The sales amount ratio is a ratio of the total purchase amount of one decile to the sales.

In an example, the transaction performance can be transaction performance (G). The transaction performance (G) is an aggregation value obtained by summing up the transaction amounts on a per commodity item basis. The transaction performance (G) corresponds to sales of each commodity at a store. The processing data can be the transaction performance (G) on a per processing unit (group) basis. The second data processing unit 115 can obtain the transaction performance (G) based on the transaction amounts included in the second POS data.

The transaction performance can be transaction performance (H). The transaction performance (H) is an aggregation value obtained by summing up the transacted quantities for on a per commodity item basis. The transaction performance (H) corresponds to the sales quantity for each commodity by store. The processing data can be the transaction performance (H) on a per processing unit (group) basis. The second data processing unit 115 can obtain the transaction performance (H) based on the transacted quantities included in the second POS data.

The transaction performance can be transaction performance (I). The transaction performance (I) is an aggregation value obtained by summing up the transaction amounts for each decile for a commodity. The transaction performance (I) corresponds to the total purchase amount for each decile per customer. The processing data can be the transaction performance (I) on a per processing unit (group) basis. The second data processing unit 115 can obtain the transaction performance (I) based on the transaction amounts included in the second POS data.

The transaction performance can be transaction performance (J). The transaction performance (J) includes a statistical value obtained by dividing the transaction performance (G) for each commodity by the transaction performance (I) for each decile. The statistical value is a ratio. The transaction performance (J) corresponds to the sales amount ratio for each decile of each commodity by store. The processing data can be the transaction performance (J) on a per processing unit (group) basis. The second data processing unit 115 can obtain the transaction performance (J) based on the transaction amounts included in the second POS data.

For example, the processing data can include all or a part of the transaction performance (G), the transaction performance (H), the transaction performance (I), and the transaction performance (J) for each commodity for all stores collectively. The processing data can include all or a part of the transaction performance (G), the transaction performance (H), the transaction performance (I), and the transaction performance (J) for each commodity in the entire target period.

A display of “ABCD analysis” content can be a display based on the transaction performance (G) in relation to the sales of each commodity. The display of “ABCD analysis” content can be a display based on the transaction performance (H) in relation to the sales quantity of each commodity. The display of “ABCD analysis” content can be a display based on the transaction performance (J) in relation to the sales amount ratio for each decile of each commodity. The display of “ABCD analysis” content is not limited to the above-described examples.

The retailer can understand the purchase trend of each commodity for each decile using the content of “ABCD analysis”. For example, the retailer can easily grasp a commodity which is purchased by a customer in decile having a large purchase amount and has low sales as a whole.

The “brand switch” content will be described.

The “brand switch” content is a content related to sales performance of each commodity for a predetermined period within a target period. For example, the sales performance includes all or part of the sales quantity and sales, but is not limited thereto.

In the example, the transaction performance can be transaction performance (K). The transaction performance (K) is an aggregation value obtained by summing up the transacted quantities for each commodity for predetermined periods in a target period (range). The transaction performance (K) corresponds to the sales quantity of each commodity in each predetermined period in the target period by store. The processing data includes the transaction performance (K) on a per processing unit (group) basis. The second data processing unit 115 can obtain the transaction performance (K) based on the transacted quantity included in the second POS data.

The transaction performance can be transaction performance (L). The transaction performance (L) is an aggregation value obtained by summing up the transaction amounts for each commodity for each predetermined period in the target period. The transaction performance (L) corresponds to the sales of each commodity in each predetermined period in the target period by store. The processing data includes the transaction performance (L) on a per processing unit (group) basis. The second data processing unit 115 can obtain the transaction performance (L) based on the transaction amounts included in the second POS data.

For example, the processing data can include all or a part of the transaction performance (K) and the transaction performance (L) for each commodity for each predetermined period in the target period for all stores collectively.

A display of “brand switch” content can be a display based on the transaction performance (K) in relation to the sales quantity for each commodity for each predetermined period in the target period. The display of “brand switch” content can be a display based on the transaction performance (K) in relation to the sales for each commodity for each predetermined period in the target period. The display of “brand switch” content is not limited to the above-described examples.

The retailer can understand a transition in a customer purchase trend for each commodity over time (in time series) using the “brand switch” content. For example, the retailer can clarify the brand switch by the transition of the purchase trend for similar or related commodities. Accordingly, the retailer can find a beneficial bargain-priced commodity to pair with another commodity.

The “dynamic pricing” content will be described.

The “dynamic pricing” content is a content related to sales performance for a specific commodity within different time zones (time ranges) during a workday or the like. For example, the sales performance includes all or a part of the sales quantity, an average sales price, the sales, and the number of customers, but is not limited thereto. The average sales price is an average value of sales prices of the specific commodity. The number of customers is the number of customers who visit the store regardless of whether the specific commodity was purchased. The specific commodity is a commodity whose sales price varies according to time zone (range). For example, the specific commodity can be a commodity such as a prepared dish, fish, or meat, but is not limited thereto. For example, the workday may be divided into time zones set as every hour, but is not limited thereto.

In the example, the transaction performance can be transaction performance (M). The transaction performance (M) is an aggregation value obtained by summing up the transacted quantities for the specific commodity for each time zone. The transaction performance (M) corresponds to the sales quantity for the specific commodity for each time zone by store. The processing data includes the transaction performance (M) on a per processing unit (group) basis. The second data processing unit 115 can obtain the transaction performance (M) based on the transacted quantities included in the second POS data.

The transaction performance can be transaction performance (N). The transaction performance (N) is a statistical value obtained by averaging the transaction prices for a specific commodity within each time zone. The statistical value can be an average value. The transaction performance (N) corresponds to the average sales price for the specific commodity for each time zone by store. The processing data includes the transaction performance (N) on a per processing unit (group) basis. The second data processing unit 115 can obtain the transaction performance (N) based on the transaction prices included in the second POS data.

The transaction performance can be transaction performance (O). The transaction performance (O) is an aggregation value obtained by summing up the transaction amounts for the specific commodity for each time zone. The transaction performance (O) corresponds to the sales for the specific commodity for each time zone by store. The processing data includes the transaction performance (O) on a per processing unit (group) basis. The second data processing unit 115 can obtain the transaction performance (O) based on the transaction amounts included in the second POS data.

The transaction performance can be transaction performance (P). The transaction performance (P) is an aggregation value obtained by counting the unique member numbers for associated with purchases of a specific commodity in each time zone. The transaction performance (P) corresponds to the number of customers buying the specific commodity in each time zone by store. The processing data includes the transaction performance (P) on a per processing unit (group) basis. The second data processing unit 115 can obtain the transaction performance (P) based on the member numbers included in the second POS data.

For example, the processing data can include all or a part of the transaction performance (M), the transaction performance (N), the transaction performance (O), and the transaction performance (P) for the specific commodity for each time zone for each store.

A display related to “dynamic pricing” content can be a display based on the transaction performance (M) in relation to the sales quantity for the specific commodity for each time zone. The display related to “dynamic pricing” content can be a display based on the transaction performance (N) in relation to the average sales price for the specific commodity for each time zone. The display related to the “dynamic pricing” content can be a display based on the transaction performance (O) in relation to the sales for the specific commodity for each time zone. The display related to the “dynamic pricing” content can be a display based on the transaction performance (P) in relation to the sales quantity of the specific commodity in each time zone and in relation to the number of customers for the specific commodity in each time zone. The display of “dynamic pricing” content is not limited to the above-described examples.

The retailer can understand the appropriateness of the sales price for the specific commodity in each time zone using the “dynamic pricing” content.

The “commodity alignment” content will be described.

The “commodity alignment” content is a content related to the sales performance on commodity basis. For example, the sales performance includes all or a part of a total sales quantity and sales prices in each store, but is not limited thereto. The total sales quantity is obtained by summing up the sales quantities of the commodity sold by each store. The sales price is a price at which the commodity is sold at each store.

In the example, the transaction performance can be transaction performance (Q). The transaction performance (Q) is an aggregation value obtained by summing up the transacted quantities for each commodity. The transaction performance (Q) corresponds to the total sales quantity by store. The processing data includes the transaction performance (Q) on a per processing unit (group) basis. The second data processing unit 115 can obtain the transaction performance (Q) based on the transacted quantity included in the second POS data.

The transaction performance can be transaction performance (R). The transaction performance (R) is a statistical value obtained by averaging the transaction prices for a commodity at each store. The statistical value is an average value. The transaction performance (R) corresponds to the sales prices in each store. The processing data includes the transaction performance (R) on a per processing unit (group) basis. The second data processing unit 115 can obtain the transaction performance (R) based on the transaction prices included in the second POS data.

For example, the processing data can include all or a part of the transaction performance (Q) and the transaction performance (R) in the entire target period.

A display related to “commodity alignment” content can be a display based on the transaction performance (Q) in relation to the total sales quantity of each commodity. The display related to “commodity alignment” content can be a display based on the transaction performance (R) in relation to the sales price of each commodity in each store. The display of “commodity alignment” content is not limited to the above-described examples.

The retailer can compare the purchase trend of each commodity between stores using the “commodity alignment” content. For example, by comparing the sales prices between stores, the retailer can understand whether returning of the sales price is forgotten.

FIG. 6 is a flowchart showing another example of the output processing of the display information performed by the processing circuit 11 of the server 1.

Here, it is assumed that the extraction condition has already been set for the retailer.

The second data processing unit 115 detects that a predetermined timing has been reached (ACT 31). The predetermined time may be set by or for a retailer or system user. When the predetermined timing is not yet reached (ACT 31, NO), the second data processing unit 115 continues the processing of ACT 31. When the predetermined timing is reached (ACT 31, YES), the processing transitions from ACT 31 to ACT 32.

The second data processing unit 115 generates, based on the already set extraction condition(s), the display information including content based on the available second POS data (ACT 32). In ACT 32, similarly to ACT 22, the second data processing unit 115 searches the POS data storage area 132 for second POS data satisfying the extraction condition(s). The second data processing unit 115 generates the display information based on second POS data satisfying the extraction condition.

The second communication processing unit 114 may acquire an output request (ACT 33). For example, in ACT 33, the second communication processing unit 114 acquires an output request from a terminal 3 via the communication interface 14. Here, it is assumed that the user accesses the server 1 using the terminal 3 to display, on the terminal 3, particular content selected from a plurality of possible content. The user inputs an output instruction using the terminal 3. The terminal 3 outputs the output request to the server 1.

The second communication processing unit 114 then outputs the display information generated by the second data processing unit 115 (ACT 34). For example, in ACT 34, the second communication processing unit 114 outputs the display information to a particular terminal 3 via the communication interface 14. The terminal 3 displays an image of the content (content image) based on the display information.

Here, the user of terminal 3 may view content associated with second POS data of a particular retailer, store, grouping of stores, store chain, brand, or the like. Access to second POS data for any particular user may be limited to a particular retailer, store, grouping of stores, store chain, brand, or the like, or there may be no limits placed on the access to the second POS data. User access may be set according authorization levels or the like.

Setting of the extraction conditions as performed by the processing circuit 11 of the server 1 will be described.

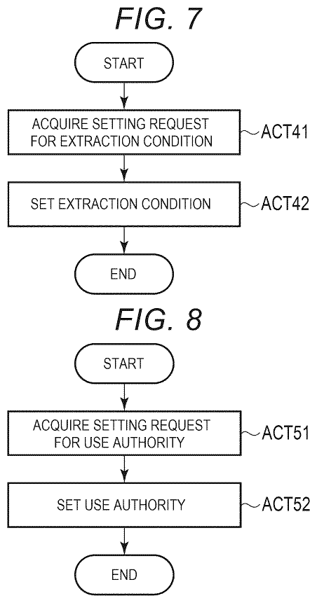

FIG. 7 is a flowchart showing an example of the setting processing for the extraction conditions as performed by the processing circuit 11 of the server 1.

Here, the user accesses the server 1 using a terminal 3 in order to set the extraction condition(s). The user uses the terminal 3 to input or select various extraction conditions related to the content. For example, the user may limit extraction to a particular store associated with the user, but data/content access authority need not be limited for the user in any particular manner. After inputting an extraction condition, the user inputs a setting instruction using the terminal 3. The setting instruction causes the server 1 to set (e.g., save) the extraction condition. The terminal 3 outputs a setting request for the extraction condition to the server 1. The setting request causes the server 1 to set the extraction conditions to be used.

The second communication processing unit 114 acquires the setting request for the extraction condition (ACT 41). In ACT 41, the second communication processing unit 114 acquires the setting request from the terminal 3 via the communication interface 14.

The second data processing unit 115 the sets extraction condition based on the user inputs at the terminal 3 (ACT 42). In ACT 42, for example, the second data processing unit 115 sets the extraction condition as indicated by setting request. The second data processing unit 115 stores the set extraction conditions in the setting information storage area 133.

As described above, the server 1 can set the extraction condition based on the input operations performed at the terminal 3 by a user.

As described above, by presetting the extraction condition, the user can omit having to input an extraction condition each time content is to be displayed on the terminal 3.

Setting processing of the use authority or access level as performed by the processing circuit 11 of the server 1 will be described.

FIG. 8 is a flowchart showing an example of the setting processing for the use authority.

Here, the user accesses the server 1 by using a terminal 3 in order to set use authority to permit another vendor/user access to content based on second POS data that the vendor/user did not generate or initially have authority to access. The user uses the terminal 3 input the use authority. Information indicating the use authority input using the terminal 3 is also referred to as input information related to the use authority. The input information related to the use authority includes information indicating another vendor or vendors to be given access. After inputting the use authority, the user inputs a setting instruction using the terminal 3. The setting instruction causes the server 1 to set the use authority as directed. The terminal 3 outputs a setting request related to the use authority to the server 1. The setting request is a request for causing the server 1 to set a use authority.

The second communication processing unit 114 acquires the setting request (ACT 51). In ACT 51, for example, the second communication processing unit 114 acquires the setting request via the communication interface 14.

The second data processing unit 115 sets the use authority as indicated by the setting request (ACT 52). For example, in ACT 52, the second data processing unit 115 sets the use authority of another vendor to provide the other vendor access to product sales information of an additional store, group, or the like. The second data processing unit 115 stores the use authority setting information in the setting information storage area 133.

As described above, the server 1 can set the use authority levels.

In this way, the server 1 can support the distribution of the POS data from a retailer to another vendor.

By using a platform provided by the server 1 that manages the POS data of a retailer, the retailer can easily distribute POS data of the retailer to a data analysis vendor or the like.

### Display Example

An example of an image displayed on a display device 31 of the terminal 3 will be described.

The display device 31 can be a liquid crystal display or an organic electroluminescence (EL) display, but is not limited thereto.

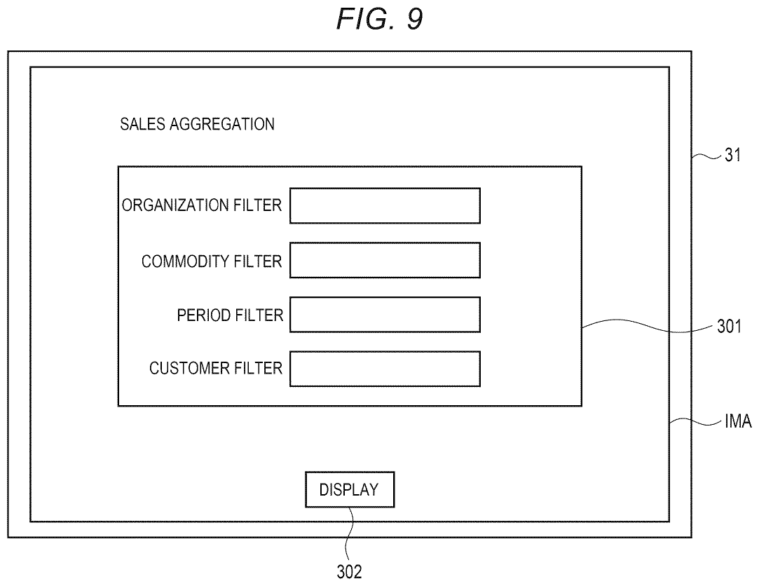

FIG. 9 is a diagram showing an example of an image for inputting the extraction conditions that can be displayed on the display device 31 of the terminal 3.

The display device 31 displays an image IMA for inputting the extraction conditions related to the specific content. Here, the content is “sales aggregation” content. The extraction condition is input for displaying particular “sales aggregation” content on the display device 31.

The image IMA includes an area 301 in which a extraction condition can be input. The area 301 includes an area for “organization filter”, an area for “commodity filter”, an area for “period filter”, and an area for “customer filter”. The area for “organization filter” is an area in which conditions related to a store owned by a specific retailer can be input. The area for “commodity filter” is an area in which conditions related to a commodity can be input. The area for “period filter” is an area in which conditions related to a period can be input. The area for “customer filter” is an area in which conditions related to a customer attribute can be input.

The image IMA includes a “display” button 302 capable of inputting an output instruction.

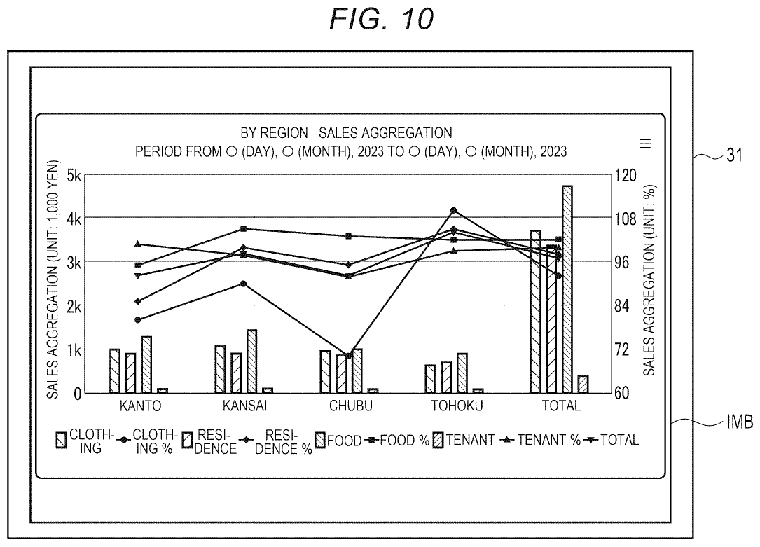

FIG. 10 is a diagram showing an example of a content image displayed on the display device 31 of the terminal 3.

The display device 31 displays an image IMB (content image) based on the display information supplied by server 1 or the like. It is assumed here that the display information is generated by the server 1 based on the extraction conditions input via the image IMA shown in FIG. 9. Here, the content is “sales aggregation” content.

The image IMB in this example displays transaction performance (B) in a bar graph format as sales aggregation content. The bar graph format is one example of a display based on the first transaction performance (B). For “sales aggregation” content, the transaction performance (C) is also displayed in a line graph format with values established as a previous year ratio (%). The display in the line graph format is an example of the display based on the transaction performance (C). Here, values of the sales aggregation and the previous year ratio of the sales aggregation are values in the entire target period for each combination of the commodity type and the area.

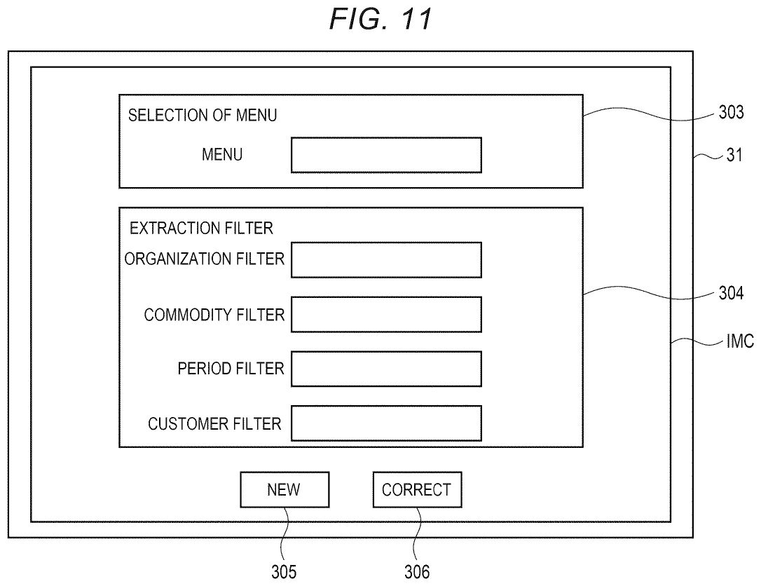

FIG. 11 is a diagram showing an example of an image for inputting the extraction condition displayed on the display device 31 of the terminal 3.

The display device 31 displays an image IMC for inputting extraction conditions set.

The image IMC includes an area 303 in which a menu can be selected. In this context, the menu can be selected for setting particular types of extraction conditions that might be related to content types.

The image IMC includes an area 304 in which particular extraction conditions can be input. The area 304 includes an area for “organization filter”, an area for “commodity filter”, an area for “period filter”, and an area for “customer filter”. The area for “organization filter” is an area in which conditions related to a store owned by a specific retailer can be input. The area for “commodity filter” is an area in which conditions related to a commodity can be input. The area for “period filter” is an area in which conditions related to a period can be input. The area for “customer filter” is an area in which conditions related to a customer attribute can be input.

The image IMC includes a “new” button 305 and a “correct” button 306 for inputting a setting instruction for the extraction conditions. The “new” button 305 is a button for a setting instruction of a newly set extraction condition. The “correct” button 306 is a button for a setting instruction for updating a previously set extraction condition.

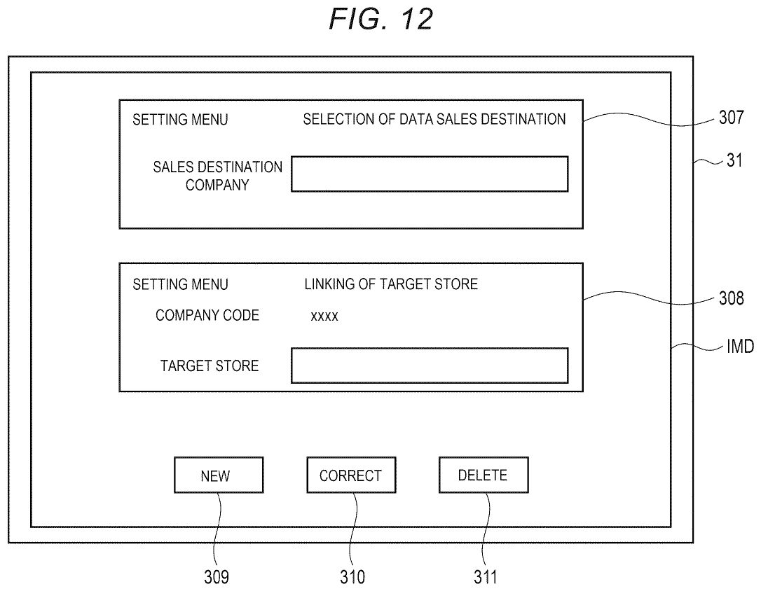

FIG. 12 is a diagram showing an example of an image displayed on the display device 31 of the terminal 3 for inputting use authority.

An image IMD includes an area 307 in which a sales destination company can be input. The sales destination company is another vendor to which the retailer gives use authority.

The image IMD includes an area 308 in which a range of the stores owned by the retailer can be input as the use authority.

The image IMD includes a “new” button 309 and a “correct” button 310. The “new” button 309 is for a new setting of use authority. The “correct” button 310 is for updating a previously set use authority.

The image IMD includes a “delete” button 311 for inputting a use authority deletion instruction. The use authority deletion instruction is an instruction for causing the server 1 to delete a previously set use authority.

### Effects

According to the embodiment, the server 1 can store the second POS data in the POS data storage area 132 based on the first POS data. The server 1 can output information based on a plurality of pieces of second POS data.

Accordingly, the server 1 can provide a platform that manages the POS data in a unified format and outputs information corresponding to various content based on the POS data in the unified format. By providing such a platform, the server 1 can support distribution of POS data such as collection of the POS data and output of information based on the POS data.

Since the retailer does not need to cooperate data with each data service operator in a format specific to each data service operator, a workload on the retailer is reduced. The retailer can more easily acquire the information corresponding to various content from various data service operators and the like.

### Other Embodiments

An embodiment may be implemented as a method executed by a system. An embodiment may be implemented as a software program of the like including program instructions enabling a computer (or a system of computers) to execute described functions. Such a program of an embodiment may be implemented as a non-transitory, computer-readable recording medium that stores the program.

A circuit or circuits constituting the processing circuit in an embodiment executes one or more processing among the plurality of described processing functions. When the processing circuit is implemented as a single circuit, the single circuit executes all of the processing. When the processing circuit comprises a plurality of circuits, each may execute a part of the processing. When the processing circuit includes a plurality of circuits, the plurality of circuits may be incorporated within in one device or may be distributed among a plurality of devices.

A program of an embodiment may be stored in a device and transferred to an end user or the like or transferred separately from a device. In the latter case, the program may be transferred via a network or recorded on a recording medium. The recording medium can be any non-transitory tangible medium that is computer-readable. The recording medium format is not limited as long as it can store the program and can be read by a computer. For example, the recording medium may be a CD-ROM or a memory card.

While certain embodiments have been described, these embodiments have been presented by way of example only, and are not intended to limit the scope of the exemplary embodiments. These novel embodiments can be implemented in various other forms, and various omissions, substitutions, and modifications can be made without departing from the gist of the disclosure. The embodiments and the modifications thereof are included in the scope and the spirit of the disclosure, and are included in a scope of the invention disclosed in the claims and equivalents thereof.

What is claimed is:

1. An information processing system, comprising:
a first communication processing unit configured to acquire transaction data related to sales transactions in a plurality of data formats;
a first data processing unit configured to store, in a storage unit, the transaction data in a predetermined format;
a second data processing unit configured to generate sales analysis information based on pieces of the transaction data in the predetermined format stored in the storage unit; and
a second communication processing unit configured to output the sales analysis information generated by the second data processing unit.

2. The information processing system according to claim 1, wherein the transaction data is received from a point-of-sale device as part of an inquiry for coupon information from the point-of-sale device.

3. The information processing system according to claim 1, wherein the first data processing unit converts a format of the acquired transaction data into the predetermined format.

4. The information processing system according to claim 1, wherein the second data processing unit generates the sales analysis information based on a subset of the transaction data extracted from the stored transaction data in the predetermined format based on an extraction condition set based on a request from a user terminal received via the second communication processing unit.

5. The information processing system according to claim 1, wherein the stored transaction data is associated with a user authority setting.

6. An server for a multiuser sales data analysis system, the server comprising:
a storage device;
a communication interface; and
a processing circuit configured to:
acquire transaction data related to sales transactions in a plurality of data formats via the communication interface from a plurality of point-of-sale devices;
store, in the storage unit, the acquired transaction data in a predetermined format regardless of an initial format of the transaction data when acquired;
generate sales analysis information based on pieces of the transaction data in the predetermined format stored in the storage unit; and
output the generated sales analysis information to a user terminal via the communication interface.

7. The server according to claim 6, wherein the transaction data is received from a point-of-sale device as part of an inquiry for coupon information from the point-of-sale device.

8. The server according to claim 6, wherein the processing circuit converts the initial format of the acquired transaction data into the predetermined format.

9. The server according to claim 6, wherein the processing circuit generates the sales analysis information based on a subset of the transaction data extracted from the stored transaction data in the predetermined format based on an extraction condition set based on a request from the user terminal.

10. The server according to claim 6, wherein the stored transaction data is associated with a user authority setting.

11. An information processing method for a server for a multiuser sales data analysis system, the method comprising:
acquiring transaction data related to sales transactions in a plurality of data formats via a communication interface from a plurality of point-of-sale devices;
storing, in a storage unit, the acquired transaction data in a predetermined format regardless of an initial format of the transaction data when acquired;
generating sales analysis information based on pieces of the transaction data in the predetermined format stored in the storage unit; and
outputting the generated sales analysis information to a user terminal via the communication interface.

12. The method according to claim 11, wherein the transaction data is received from a point-of-sale device as part of an inquiry for coupon information from the point-of-sale device.

13. The method according to claim 11, wherein a processing circuit of the server converts the initial format of the acquired transaction data into the predetermined format.

14. The method according to claim 11, wherein the sales analysis information is generated based on a subset of the transaction data extracted from the stored transaction data in the predetermined format based on an extraction condition set based on a request from the user terminal.

15. The method according to claim 11, wherein the stored transaction data is associated with a user authority setting.

16. The method according to claim 11, further comprising:
receiving a coupon inquiry from a point-of-sale terminal as part of a sales transaction processing event.

17. The method according to claim 16, wherein the sales transaction data is received from the point-of-sale terminal as part of the coupon inquiry.

18. The method according to claim 11, wherein the transaction data is acquired from point-sale-terminals operated at different stores.

19. The method according to claim 18, wherein the different stores are owned by different retailers.

20. The method according to claim 19, wherein the stored transaction data is associated with a user authority setting limiting access to particular retailers.
